(19) United States
(12) Patent Application Publication
(10) Pub. No.: US 2019/0266146 A1
(43) Pub. Date: Aug. 29, 2019

(54) SECURE AUDITING SYSTEM BASED ON VERIFIED HASH ALGORITHM

(71) Applicant: Saavha, Inc., New York, NY (US)

(72) Inventors: Mathew E. Rose, Ambler, PA (US); Colin McCann, Arlington, VA (US); Jeremy Gardner, Miami Beach, FL (US); Justin Mahon, Mount Juliet, TN (US); Gregory Allan Rossel, Huntsville, AL (US)

(21) Appl. No.: 16/348,909

(22) PCT Filed: Nov. 10, 2017
(86) PCT No.: PCT/US2017/061173

§ 371 Date: May 10, 2019

Related U.S. Application Data
(60) Provisional application No. 62/420,438, filed on Nov. 10, 2016.

(51) Int. Cl. G06F 16/23; G06F 16/22; G06F 16/11; G06F 16/215; H04L 9/06; G06F 16/21; G06F 21/60

(52) U.S. Cl. CPC G06F 16/2365; G06F 16/2255; G06F 16/113; G06F 16/215; H04L 2209/38; H04L 9/0643; G06F 16/219; G06F 21/602; H04L 9/0637

(57) ABSTRACT

A secured auditing system using verified hash algorithms is provided. The system integrates with existing databases (e.g., appointment databases) to receive and store auditable data in a system database. The system generates a hash (i.e., a digital signature) for each piece of auditable data received and stores the hash in the system database and on a decentralized blockchain platform for comparative auditing. The system is not confined to one blockchain platform and can interact with any existing blockchain or distributed ledger technology as it evolves.

### CROSS REFERENCES TO RELATED APPLICATIONS

This application is a national stage application, and claims priority to, International Patent Application No. PCT/US2017/061173, filed Nov. 10, 2017, which in turn claims priority to and hereby incorporates by reference in its entirety U.S. Provisional Patent Application No. 62/420,438 entitled “SECURED AUDITING SYSTEM BASED ON VERIFIED HASH ALGORITHM” filed on Nov. 10, 2016.

### TECHNICAL FIELD

The present invention relates generally to systems for verifying data in a database. More particularly, this invention pertains to systems for ensuring that records (e.g., logs) in a database cannot be altered, even by system administrators.

### BACKGROUND

Prior art systems for data verification and auditing data in a subject database use one or more secure database backups and compare each data point in the subject database to each data point in one or more of the secure database backups to confirm that the data points are the same in each of the databases. These systems create several issues.

The data stored in a secured database backup is subject to modification. Should an internal entity (e.g., database administrator) or external hacker, for example, know the location of both the subject database and the secure database backup, the data could be modified in either or both databases. When checked, it would appear that all data points were correct, and there generally would not be a record of the change in the data points.

The data points stored in the secure database backups must be the actual raw data or an encrypted version thereof for comparison to the subject database. This presents additional security risks and liability if the data in the subject database is sensitive information, such as protected health information or personally identifiable information.

Because the raw data or an encrypted version thereof must be stored on each secure database backup, databases require more than double the storage capacity of the actual database. For very large databases, storage capacity is problematic from a system management and storage cost standpoint.

### SUMMARY

Aspects of the present invention provide a secured auditing system using verified hash algorithms. The system integrates with existing databases (e.g., appointment databases) to receive and store auditable data in a database. The system generates a hash (i.e., a digital signature) for each piece of auditable data received and stores the hash in the database and on a decentralized blockchain for comparative auditing. The system is not confined to one blockchain platform and can interact with any existing blockchain platform or evolution of distributed ledger technology platforms.

In one aspect, a system for providing an auditable log includes a system secure archiver, a blockchain interface, and a system database. The system secure archiver is configured to receive a data package entered into the client archive system and to create a hash of the received data package. The blockchain interface is configured to store the created hash on a blockchain and receive a storage receipt and timestamp corresponding to the created hash. The system database is configured to store the data package, the created hash, and storage receipt and associated timestamp.

In another aspect, a system for auditing a client archive system includes an audit engine. The audit engine is configured to audit the client archive system. The client archive system has a corresponding auditable log provided by a system secure archiver. The auditable log includes a system database and a plurality of hashes stored on a blockchain platform. The audit engine is configured to receive audit data from a client data collection application associated with the client archive system. The audit data includes at least one data package. The audit engine retrieves data from the system database corresponding to the data package. The audit engine provides a notification to a system administrator of at least one difference between the retrieved data from the system database and the audit data received from the client data collection application.

### BRIEF DESCRIPTION OF THE DRAWINGS

FIG. 1 is block diagram showing a system for auditing a client archive system (i.e., a client database).

FIG. 2 is a partial block diagram and flow chart showing acquiring new data in a system and saving the data using a blockchain platform for auditing a client archive system.

FIG. 3 is a partial block diagram and flow chart showing creating system change logs in a system and saving the data using a blockchain platform for auditing a client archive system.

FIG. 4 is a partial block diagram and flow chart showing verifying system change logs in a system and saving the data using a blockchain platform for auditing a client archive system.

FIG. 5 is a partial block diagram and flow chart showing verifying data against change logs in a system database for auditing a client archive system.

FIG. 6 is a partial block diagram and flow chart showing verifying data in a system database for auditing a client archive system.

FIG. 7 is a partial block diagram and flow chart showing a system audit engine detecting changes in a client archive system using a system database.

FIG. 8 is a partial block diagram and flow chart showing a system audit engine identifying the history of changes to data in a client archive system using a system database in a system for auditing the client archive system.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The terms “coupled” and “connected” mean at least either a direct electrical connection between the connected items or an indirect connection through one or more passive or active intermediary devices.

The term “circuit” means at least either a single component or a multiplicity of components, either active and/or passive, that are coupled together to provide a desired function.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

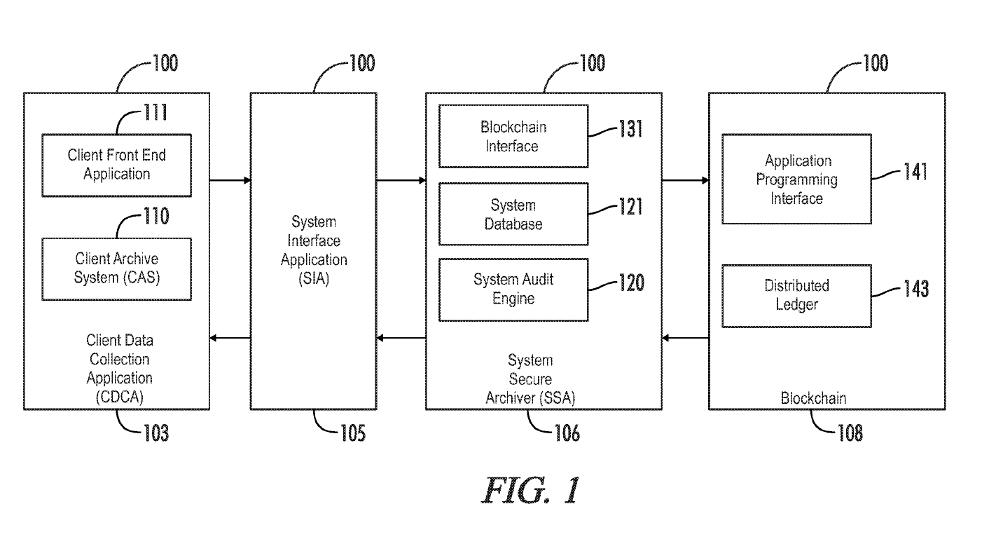

Referring to FIG. 1, a system (i.e., SAA) 100 for auditing a client database includes a client data collection application 103, a system interface application 105, the system secured archiver 106, and blockchain platform 108. The client data collection application 103 operates on a client's archive system 110 (i.e., an existing database) and provides data to the system interface application 105. The client data collection application 103 may monitor the client archive system 110 for changes and provide the changes to the system interface application 105 or provide complete data sets as they are entered into a client front end application 111. The system interface application 105 periodically polls the client data collection application 103 for these changes to the client archive system (CAS) 110, or the client data collection application 103 automatically pushes such changes to the system interface application 105.

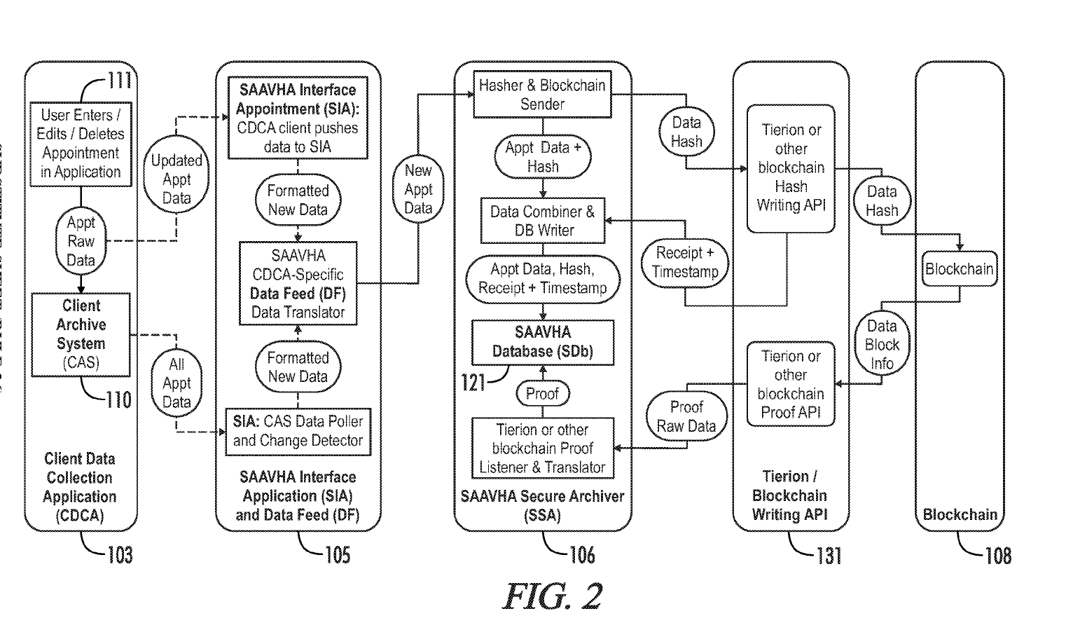

Referring generally to FIGS. 1-6, the system interface application 105 interacts directly with the client data collection application 103 (see especially FIG. 2). The client data collection application 103 is an application similar to Outlook, Gmail, or other front-end, user-facing programs that the client uses to input data into an electronic storage system (i.e., existing database) 110. As the client data collection application operators enter information to send to the client archive system 110, the entered data is simultaneously sent to the system secured archiver 106 for storage in the system generated database 121 in a raw or encrypted format. Such format will be determined by the client or the operator when the system 100 is installed. The system interface application 105 is configured to receive data from the client data collection application 103 and format the received data to generate a data package for the system secure archiver 106.

In one embodiment, the system interface application 105 is configured to receive data from the client data collection application 103, format the received data, encrypt the formatted received data to create an encrypted data package, and provide the encrypted data package to the system secure archiver 106 via a communications network (e.g., Internet). The system secure archiver 106 is configured to decrypt encrypted data package to receive the data package for hashing and storage in the system database 121. In this embodiment, the client data collection application 103 transmits changes to the system interface application 105 as any such changes (i.e., data) is entered into the client front end application 111 (i.e., client user interface) and stored in the client archive system 110. The system interface application 105 formats the transmitted changes as the data package for the system secure archiver 106.

In another embodiment, the system interface application 105 is configured to periodically poll the client data collection application 103 at the client archive system 110 for changes to the client archive system 110, determine changes to the client archive system 110, and generate the data package for the system secure archiver 106 as a function of the determined changes to the client archive system 110. Thus, in this embodiment, data is provided to the system interface application 105 and system secure archiver 106 after it is entered into the client archive system 110. The system interface application 105 formats the data as it is received as the data package for the system secure archiver 106.

Any interface that feeds data into the system secure archiver 106 or system audit engine 120 is a data feed. The client front end application 111 reviews all data fields (i.e., parameters) the client collects and presents them to the client, giving the client the ability to select what data is sent through the data feed for auditing and whether the data requires encryption when stored on the system database 121. The data feed (i.e., string of data packages) enters the system secure archiver 106, and the system secure archiver 106 places the auditable data in a raw or encrypted format (as specified at system 100 setup on a per parameter basis) for storage on the system generated database 121. This data undergoes a hashing process using SHA-256 or another more advanced hashing algorithm to create a unique limited character number sequence that creates a digital signature (i.e., a hash) for the data provided. As known by a person of ordinary skill, a hash function is a mathematical process that receives data, transforms the data, and produces an output of a fixed size. Using cryptographic hash functions, it is almost impossible to produce the same hash output. Any slight change in the existing data as small as a space or period will create a change in the hash output. Additionally, identical data will create an identical hash. A second feature of cryptographic hash functions is that the output will always be a set number of characters (e.g., the SHA-256 hash algorithm creates hashes that are always 256 bits). The hash generated will be stored on the system generated database 121 and simultaneously placed on an existing established blockchain platform 108 for immutable storage. It is understood by one skilled in the art that the blockchain platform 108 may comprise any public or private blockchain platform such as Tierion, Ethereum, Interplanetary File System (IPFS), Tenderment, BigChainDB, Hashgraph, or any new technological advancement that provides an improved method of storing data in an immutable format.

Client generated data is stored in the client's electronic data storage solution or client archive system (CAS) 110. The secured system archiver 106 includes at least one management algorithm or engine 120 and a system generated database 121. The system generated database 121 stores raw data and/or unique hashes/encryptions of raw data from which cryptographic hashes are made and stored on the blockchain platform 108. The system generated database 121 can be stored within a client's secured server or within a system-secured server unaffiliated with a client. Similarly the system interface application 105 may reside at the client or at a separate server unaffiliated with the client. If stored on a separate server, data fed from the system interface application 105 to the system secure archiver 106 is encrypted while in transit. If the system interface application 105 is separate from the client, then data fed to the system interface application 105 is encrypted while in transit from the client data collection application 103 to the system interface application 105.

The system 100 provides an auditable log of the client archive system 110. The system 100 includes the system secure archiver 106, blockchain interface 131, and the system database 121. The system secure archiver 106 is configured to receive a data package entered into the client archive system 110 and create a hash of the received data package. The blockchain interface 131 is configured to store the created hash on the blockchain platform 108 and receive a storage receipt and timestamp corresponding to the created hash. The system database 121 is configured to store the data package, the created hash, and the storage receipt and timestamp.

In one embodiment, the data package includes sensitive data. The system secure archiver 106 is configured to remove the sensitive data from the data package to create a scrubbed data package, append a random byte string to the scrubbed data package, and hash the scrubbed data package together with the random byte string to generate the created hash to be stored on the blockchain platform 108. This prevents sensitive information from being accessible to the public when the blockchain platform 108 is a public blockchain. This also enhances security when the blockchain platform 108 is a private blockchain.

The system database 121 associates the data package with the created hash, storage receipt, and timestamp. The timestamp is indicative of a time at which the data package has been or was stored on the blockchain platform 108 (i.e., distributed ledger 143).

In one embodiment, the system secure archiver 106 includes the blockchain interface 131 and the system database 121. Blockchain interface 131 may have a corresponding component such as an application programming interface 141 in the blockchain platform 108. The application programming interface 141 provides the receipt and timestamp to the blockchain interface 131 in response to receiving the created hash. In one embodiment, the blockchain platform 108 includes a distributed ledger 143 which may be private or public.

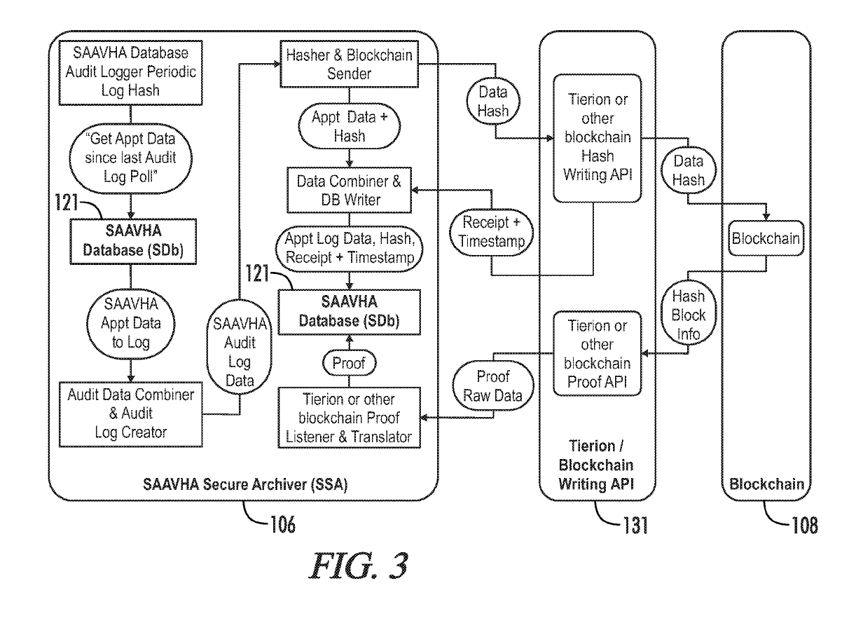

Referring especially to FIG. 3, in one embodiment, the system secure archiver 106 is further configured to periodically log changes to the system database 121. The system secure archiver 106 determines a time of the previous log, creates a log of all changes to the system database 121 based on the time of the previous log, and generates a hash from the created log. The system secure archiver 106 stores the hash generated from the created log on the blockchain platform 108 via the blockchain interface 131 and receives a receipt and timestamp corresponding to the stored hash generated from the created log from the blockchain interface 131. The system secure archiver 106 stores the created log, receipt, and timestamp in the system database 121.

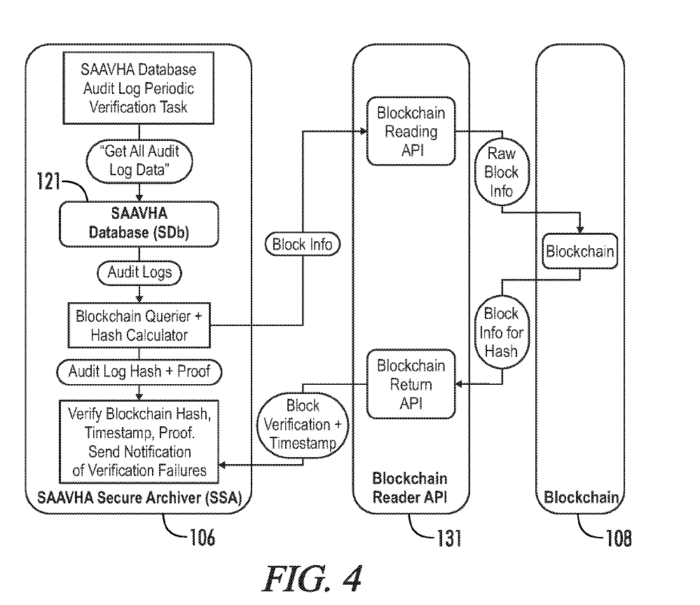

Referring especially to FIG. 4, in one embodiment, the system secure archiver 106 is further configured periodically verify the periodically created logs. The system secure archiver 106 generates a hash for each log of the periodically created logs in the system database 121. The system secure archiver 106 retrieves a corresponding hash for each of the logs from the blockchain platform 108 via the blockchain interface 131. The system secure archiver 106 compares each retrieved hash to the corresponding generated for each log the periodically created logs in the system database 121 to determine whether the log stored in the system database 121 has been altered or deleted in an unauthorized manner.

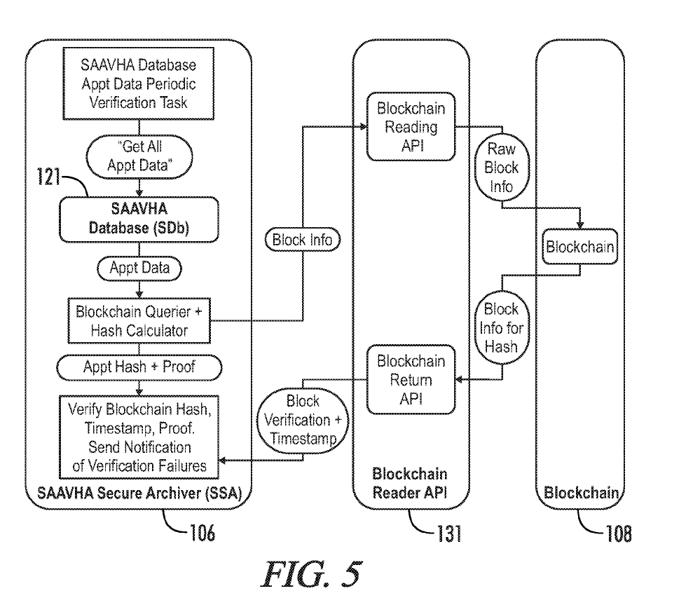

Referring especially to FIG. 5, the system secure archiver 106 is further configured to periodically verify system database 121. The system secure archiver 106 generates a hash for each data package stored in the system database 121. The system secure archiver 106 retrieves the corresponding hash for each of the data packages stored in the system database 121 from the blockchain platform 108 via the blockchain interface 131. The system secure archiver 106 compares each retrieved hash to the corresponding generated hash for each data package of the data packages stored in the system database 121 to determine whether any data in the system database 121 has been added or changed in an unauthorized manner.

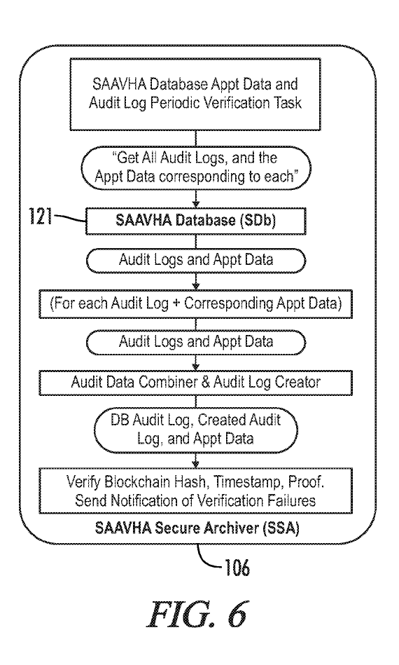

Referring especially to FIG. 6, the system secure archiver 106 is further configured to periodically verify the system database 121. The system secure archiver 106 retrieves each data package from the system database 121, and retrieves a log corresponding to each data package from the system database 121. The system secure archiver 106 then compares each retrieved data package to the corresponding log to determine whether any data has been deleted from the system database 121 in an unauthorized manner.

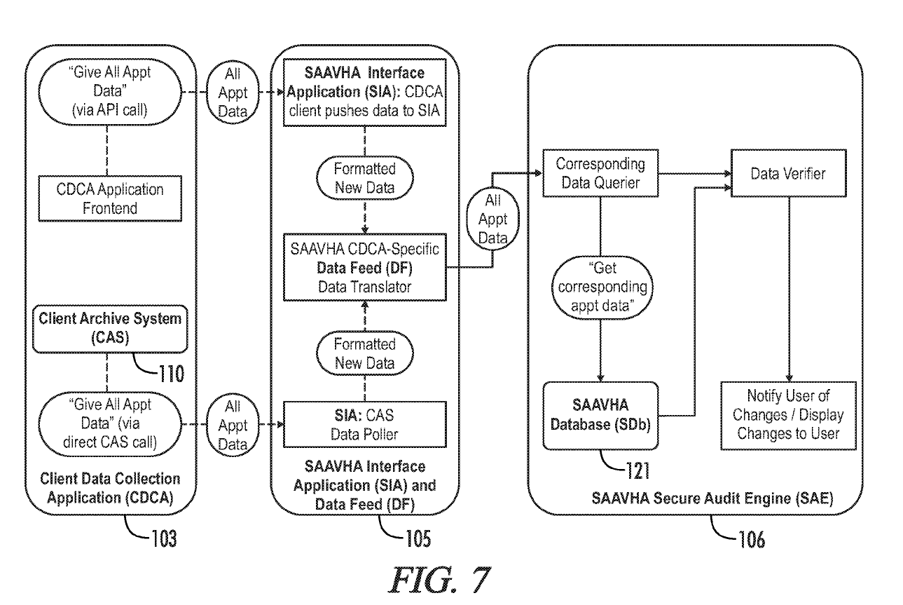

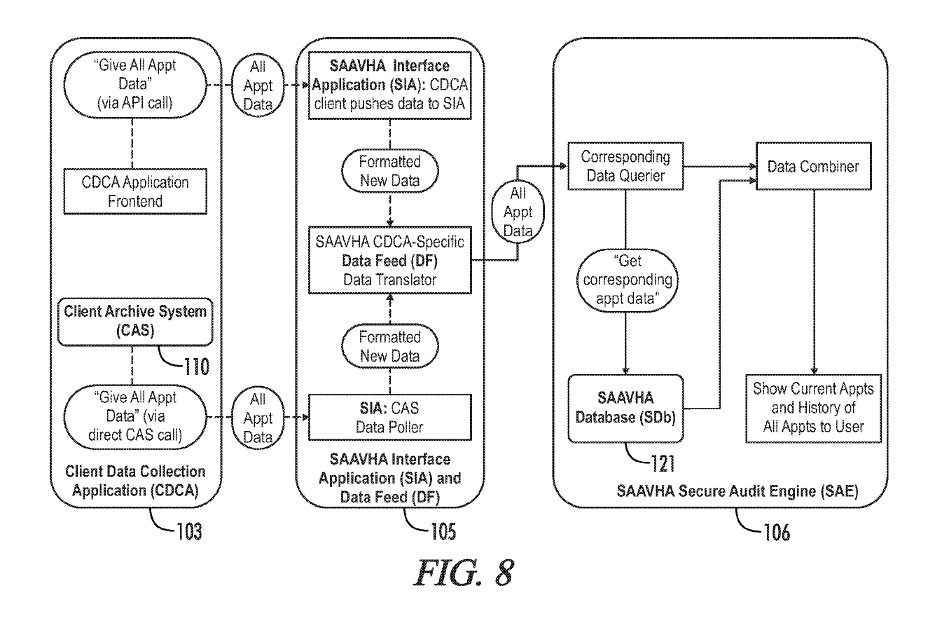

Referring especially to FIGS. 7 and 8, the system audit engine 120 compares the hashes of the client data with the immutable hashes on the blockchain platform 108. This ensures there has been no modification to the system generated database 121 and ensures no modification of the pre-specified data fields have been made in the client archive system 110, thereby validating data integrity for client use. If any data has been modified, the audit engine 120 reports to the client (e.g., a system administrator) that a change has occurred and specifically where that change occurred through a notification system using email, phone call, and/or text. The audit engine 120 provides a report when a change occurs, when a report is requested, or at pre-specified time points.

In one embodiment, the system 100 includes an audit engine 120. In one embodiment, the audit engine 120 is a part of the system secure archiver 106. The audit engine 120 is configured to audit the client archive system 110. The client archive system 110 has a corresponding auditable log provided by the system secure archiver 106. The auditable log includes the system database 121 and a plurality of hashes stored on the blockchain platform 108 the audit engine 120 is configured to receive audit data from the client data collection application 103 associated with the client archive system 110. The audit data includes at least one data package stored in the client archive system 110. The audit engine 120 retrieves data from the system database 121 corresponding to the data package. The audit engine 120 provides a notification to the system administrator of at least one difference between the retrieved data from the system database 121 and the audit data received from the client data collection application 103. The notification is indicative of an unauthorized change to data in the client archive system 110. In one embodiment, providing the notification to the system administrator includes providing a notification to a contact associated with the client archive system 110 and a contact associated with the audit engine 120. That is, the notification is provided to personnel associated with the client and associated with the owner or operator of the system 100.

In one embodiment, the received audit data includes all data corresponding to at least one auditable parameter of the client archive system 110. The auditable parameter is at least a portion of a plurality of data packages provided to the system secure archiver 106 by the client data collection application 103 for the auditable log. That is, an audit may be performed for just one parameter or data field of the entries in the client database or client archiver system 110.

In one embodiment, the audit engine 120 is further configured to periodically request the audit data from the client data collection application 103, and the client data collection application 103 is configured to provide the audit data in response to receiving said request from the audit engine 120. The client data collection application 103 may be further configured to periodically provide the audit data to the audit engine 120 without receiving a request from the audit engine 120 for the audit data. Client data collection application 103 may thus initiate an audit by the audit engine 120, or the audit may be initiated via the client front end application 111.

Providing the notification to the system administrator of the difference between the retrieved data from the system database 121 and the audit data received from the client data collection application 103 can take a couple of different forms. In one embodiment, providing the notification includes providing the history of all changes to data in the client archive system 110. In another embodiment, providing the notification includes providing a notice of at least one difference between data in the client archive system 110 and data in the system database 121.

### Appointment Database Example

In one embodiment, an appointment management system uses the above described system 100 and process to verify and audit appointments generated to confirm all records are accurate and have not been modified or deleted. The client data collection application (CDCA) 103 is described herein as an application programming interface (API) that a client or database owner would use to input data into its client archive system (CAS) 110. In this embodiment, the data package includes appointment data having generic data instances, including protected health information. The system secure archiver 106 is configured to append a random byte string (also known as “salt”) to the data package and then hash the data package along with the salt to generate the created hash entered on the blockchain platform 108. The salt value is at least as many bits as the generated hash so that no information about the hashed data (i.e., the data package) can be derived from the publicly-viewable hash.

The appointment verification system (AVS) audits on two database components: set appointment times and waitlisted names. At the time of contact requesting an appointment, the name/ID of the administrator required to access the AVS is logged along with the patient requesting an appointment. A unique identifier is created for this encounter to be hashed and a link to the patient name is created on the client archive system 110 and system secure archiver 106 (i.e., in database 121). This hash will then be linked with appointment details or a confirmation of the addition to a waiting list.

When an appointment is generated, details (i.e., data fields or auditable parameters) associated with that appointment, such as 1) time, 2) date, 3) meeting place, 4) meeting person/group/thing, 5) Admin ID generating appointment, 6) person/group/thing requesting the meeting, and 7) requestor preferred contact will be hashed along with the initial hash at point of contact. A confirmation of the new appointment is made using a system requestor confirmation system (SRCS) which will email, phone, and/or text the appointment requester notifying the requestor of the appointment and requiring the requestor to confirm receipt of the notification through an email link, a phone voice confirmation, or a text reply.

Any allowable changes to the created appointment, such as 1) a cancellation, 2) a time change, 3) a date change, 4) a meeting place change, 5) a meeting person/group change, or 6) requestor contact information will have a new hash generated using the identity of the person making the change and the change itself, combined with the original hashes to create a new unique hash for further auditing purposes. The change will be identified by the SRCS, which will email, phone, and/or text the appointment requester notifying the requestor of the change and requiring confirmation of receipt of the notification through an email link, a phone voice confirmation, or a text reply. The requestor confirmation reply will then also be hashed. All hashes generated in this process are placed on the blockchain platform 108 as they are created as an existing function of the system secure archiver 106.

When a requestor is added to the waiting list in the client archive system (i.e., client database) 110, a confirmation of the requestor's addition to the waiting list is given. The Admin ID and the confirmation of the requestor's addition to the waiting list are hashed. This hash will then be hashed with the initial request hash and a new hash of the existing waiting list. The SRCS will email, phone, and/or text the requester notifying of placement on the waiting list and requiring the requestor to confirm receipt of the notification through an email link, a phone voice confirmation, or a text reply. The details associated with this reply will be hashed and then hashed again with the initial appointment request unique encounter ID hashes. All hashes generated in this process are placed on the blockchain platform 108 when they are created as an existing function of the system secure archiver 106.

The system audit engine 120 in conjunction with a system waitlist tracking system keeps track of the time that each requestor has been on the waiting list. If an appointment cancellation occurs, patients from the waiting list will be contacted via the SRCS of the opening with an option to accept or decline the appointment date and time. Additionally, a reminder notification at client specified time points will be sent to a client employee tasked with the role of ensuring waiting list requestors are transitioned to a set appointment. This will also signal the SRCS to notify the requestor a reminder has been sent to the appropriate party within the client's organization. This system will cycle through routinely.

The system audit engine 120 will routinely compare hashes to ensure all patients have been assigned to either an appointment generation or a waiting list. Should there be any initial encounters made with no assignment to an appointment or waiting list, the encounter will be flagged for investigation and sent to the appropriate parties (i.e., system administrator) to identify the cause.

As time moves forward cryptographic hash technology becomes less secure and information placed on the blockchain using SHA-256 may be able to be cracked and may be available to the public to view. Unless the blockchain updates as cryptographic functions update, the pre-existing hashes will forever be present on the blockchain for public access. Therefore, the system does not place any sensitive information or information not otherwise publicly available on the blockchain platform 108. Any sensitive information (e.g., confidential information, personally identifiable information, or protected health information) will be encrypted and salted to a meaningless format prior to being hashed and placed on the blockchain. This raw data may undergo this process within the client's archive system 110 prior to being sent to the system secure archiver 106. Alternately, the raw data may undergo this process in the system secure archiver 106 upon receipt from the data feed.

Protected health information is not stored in the system secure archiver 106 or blockchain platform 108. Instead, the system creates a unique ID for every appointment generated based on the time an appointment is generated. These unique IDs are linked to patients in the client archive system 110 or system secure archiver 106, but no linkable patient information will be placed into the hash algorithm.

The system 100 is usable with any blockchain platform 108 or any immutable, distributed ledger platform as technology evolves. In one embodiment, the system 100 uses a merkle tree based platform to store information on the blockchain platform 108 with a single root hash and provide a log receipt to confirm all the hashes placed on the blockchain. Should the merkle tree storage system fail or a certain blockchain platform cease to be viable, the validity of pre-existing records can still be confirmed through the log receipts and the system 100 can be transitioned onto a new blockchain or similar technology solution for providing immutability of data records.

It will be understood by those of skill in the art that providing data to the system or the user interface may be accomplished by clicking (via a mouse or touchpad) on a particular object or area of an object displayed by the user interface, or by touching the displayed object in the case of a touchscreen implementation.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although embodiments of the present invention have been described in detail, it will be understood by those skilled in the art that various modifications can be made therein without departing from the spirit and scope of the invention as set forth in the appended claims.

A controller, processor, computing device, client computing device or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media. As used herein, server is not intended to refer to a single computer or computing device. In implementation, a server will generally include an edge server, a plurality of data servers, a storage database (e.g., a large scale RAID array), and various networking components. It is contemplated that these devices or functions may also be implemented in virtual machines and spread across multiple physical computing devices.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful Secured Auditing System by Verified Hash Algorithm it is not intended that such references be construed as limitations upon the scope of this invention except as set forth in the following claims.

What is claimed is:

1. A system for providing an auditable log of a client archive system, said system comprising:
a system secure archiver configured to receive a data package entered into the client archive system and create a hash of the received data package;
a blockchain interface configured to store the created hash on a blockchain and receive a storage receipt and timestamp corresponding to the created hash; and
a system database configured to store the data package, the created hash, and the storage receipt and timestamp.

2. The system of claim 1, wherein the system secure archiver comprises the blockchain interface and the system database.

3. The system of claim 1, wherein the receipt and timestamp is received in response to storing the created hash on the blockchain.

4. The system of claim 1, wherein the system database associates the data package with the created hash, storage receipt, and timestamp, and wherein the timestamp is indicative of a time that the created hash was stored on the blockchain.

5. The system of claim 1, wherein the data package comprises sensitive data and the system secure archiver is configured to remove the sensitive data from the data package to create a scrubbed data package, append a random byte string to the scrubbed data package, and hash the scrubbed data package along with the appended random byte to generate the created hash to be stored on the blockchain, and wherein the blockchain is a public blockchain.

6. The system of claim 1, wherein:
the blockchain is a public blockchain;
the data package comprises appointment data having generic data and sensitive data including protected health information; and
the system secure archiver is configured to append a random byte string to the stored data, and then hash the data along with the random byte string generate the created hash to enter on the blockchain.

7. The system of claim 1, further comprising:
a system interface application configured to receive data from a client data collection application and format the received data to generate the data package.

8. The system of claim 1, further comprising:
a system interface application configured to receive data from a client data collection application, format the received data, encrypt the formatted received data to create an encrypted data package, and provide the encrypted data package to the system secure archiver via a communications network, wherein the system secure archiver is further configured to decrypt the encrypted data package to receive the data package.

9. The system of claim 1, further comprising:
a system interface application configured to periodically poll a client data collection application at the client archive system for changes to the client archive system, determine changes to the client archive system, and generate the data package for the system secure archiver as a function of the determined changes to the client archive system.

10. The system of claim 1, further comprising:
a client data collection application at the client archive system, said client data collection application configured to:
receive changes to the client archive system from a client user interface, and
transmit the received changes to the system interface application, wherein the system interface application formats the transmitted changes as the data package for the system secure archiver.

11. The system of claim 1, wherein the system secure archiver is further configured to periodically log changes to the system database by:
determining a time of a previous log;
creating a log of all changes to the system database based on the time of the previous log;
generating a hash from the created log;
storing the hash generated from the created log on a blockchain platform via the blockchain application interface;
receiving a receipt and timestamp corresponding to the stored hash generated from the created log from the blockchain interface; and
storing the created log and receipt and timestamp in the system database.

12. The system of claim 11, wherein the system secure archiver is further configured to periodically verify the periodically created logs by:
generating a hash for each log of the periodically created logs in the system database;
retrieving a corresponding hash for each of the logs from the blockchain via the blockchain interface; and
comparing each retrieved hash to the corresponding generated hash for each log of the periodically created logs in the system database to determine whether the logs stored in the system database have been altered or deleted in an unauthorized manner.

13. The system of claim 1, wherein the system secure archiver is further configured to periodically verify the system database by:
generating a hash for each data package stored in the system database;
retrieving a corresponding hash for each of the data packages stored in the system database from the blockchain via the blockchain interface; and
comparing each retrieved hash to the corresponding generated hash for each data package of the data packages stored in the system database to determine whether any data in the system database has been added or changed in an unauthorized manner.

14. The system of claim 11, wherein the system secure archiver is further configured to periodically verify the system database by:
retrieving each data package from the system database;
retrieving a log corresponding to each data package from the system database; and
comparing each retrieved data package to the corresponding log to determine whether any data has been deleted from the system database in an unauthorized manner.

15. A system for auditing a client archive system, said system comprising:
an audit engine configured to audit the client archive system, wherein the client archive system has a corresponding auditable log provided by a system secure archiver, said auditable log comprising a system database and a plurality of hashes stored on a blockchain, wherein said audit engine is configured to:
receive audit data from a client data collection application associated with the client archive system, said audit data comprising at least one data package;
retrieved data from the system database corresponding to the data package; and
provide a notification to a system administrator of at least one difference between the retrieved data from the system database and the audit data received from the client data collection application.

16. The system of claim 15, wherein:
the notification is indicative of an unauthorized change to data in the client archive system; and
the system secure archiver comprises the audit engine.

17. The system of claim 15, wherein providing the notification to the system administrator comprises providing a notification to a contact associated with the client archive system and a contact associated with the audit engine.

18. The system of claim 15, wherein received audit data comprises all data corresponding to at least one auditable parameter of the client archive system, said auditable parameter being at least a portion of a plurality of data packages provided to the system secure archiver by the client data collection application for the auditable log.

19. The system of claim 15, wherein:
the audit engine is further configured to periodically request the audit data from the client data collection application, and the client data collection application is configured to provide the audit data in response to receiving said request from the audit engine; and
the client data collection application is configured to periodically provide the audit data to the audit engine without receiving a request from the audit engine for the audit data.

20. The system of claim 15, wherein providing the notification to the system administrator of the difference between the retrieved data from the system database and the audit data received from the client data collection application comprises:
providing a history of all changes to data in the client archive system; or
providing a notice of at least one difference between data in the client archive system and data in the system database.
